(19) United States
(12) Patent Application Publication
(10) Pub. No.: US 2007/0039244 A1
(43) Pub. Date: Feb. 22, 2007

(54) Sliding door locking rod

(75) Inventor: Stephen M. Polston, Excelsior, MN (US)

Correspondence Address: BECK AND TYSVER P.L.L.C., 2900 THOMAS AVENUE SOUTH, SUITE 100, MINNEAPOLIS, MN, 55416, US

(73) Assignee: K & J Covenant Company, LLC

(21) Appl. No.: 11/208,936

(22) Filed: Aug. 22, 2005

(51) Int. Cl. E05B 55/00

(52) U.S. Cl. 49/449

(57) ABSTRACT

A sliding patio door locking rod is designed to keep the view of the outside free of obstruction in both its vertical/inoperative position and its horizontal/operative position. Magnetic retainers hold the rod in position vertically or horizontally. A shortened version of the rod allows the door to slide open slightly to permit ventilation from outside.

### FIELD OF THE INVENTION

The present invention relates generally to home security. More particularly, it relates to a sliding door locking rod.

### BACKGROUND OF THE INVENTION

A variety of devices have been invented to serve as a secondary lock on a sliding glass patio door; that is, a door having an outer framed panel which is fixed in position and an inner framed panel which slides horizontally along tracks mounted at the top and bottom of the door frame to open or close the door. The security rod of Cohen and Evans (U.S. Pat. No. 3,328,920) includes a one-piece rod that pivots between a disengaged and an engaged position. In its disengaged position, the rod is held vertically against the door frame within a “pair of inwardly flared fingers . . . formed to provide a pinching damp”. The rod pivots about a point at its hinged end into its horizontal engaged position. When the rod is engaged, its free end (i.e., the end opposite from the pivot axis) snaps into a bracket on a side edge of the sliding panel to hold the rod horizontal. Perhaps because of the relative novelty of sliding glass patio doors at the time of the Cohen and Evans invention-the patent application was filed in 1965—the device (now known as a “charlie bar”) was mounted about mid-way up the door. The idea was to make the rod dearly visible across the panel, helping to prevent people from “thinking the space was open” and getting injured by colliding with the transparent door. Evans (U.S. Pat. No. 4,135,376) added an apparatus to lock the rod in its horizontal position.

The device of Zins (U.S. Pat. No. 4.272,113) addresses the situation where the sliding panel is the outer one. The invention of Tierney (U.S. Pat. No. 4,073,522) employs a rod split into left and right halves pivotally hinged where they join together, so that the locking rod changes from its engaged to its stored position by bending upward at its middle. The rod when operational lies horizontally along the bottom of the door frame in the track of the (inner) sliding door. McCartney (U.S. Pat. No. 5,685,582) notes possible problems with the Tierney apparatus encountering mechanical fouling caused by gradual accumulation of dirt in its central pivoting mechanism because of its position at the bottom of the door. McCartney uses a split rod similar to that of Tierney, but mostly elevated above the door track.

Like the Cohen security rod, the devices of Allenbaugh (U.S. Pat. No. 5,193,865), Brown (U.S. Pat. No. 6,382,689) and Walsh (U.S. Pat. No. 3,821,884) all obstruct the view through the door when they are in their operative positions. McCartney's locking bar obstructs the view in all its configurations. Tierney's invention appears inobtrusive in both its operative and inoperative positions, but is relatively complex and, according to McCartney, may malfunction due to accumulated dirt.

### SUMMARY OF THE INVENTION

Sliding patio doors have become commonplace, and in many households the possibility of people inadvertently crashing into them is not of particular concern. The locking rod of the present invention provides a completely unobstructed view through the patio door in both operative and inoperative positions, as well as mechanical reliability.

The locking rod is a single piece, pivotally connected at the base of the door frame. It can swing from a vertical inoperative position to a horizontal operative position. In the preferred embodiment, the rod has an essentially rectangular cross-section. The pivot axis is essentially at the line where the horizontal and vertical parts of the door frame intersect at the right edge of the fixed glass panel (assuming, without loss of generality, that the right panel is fixed and the left panel slides rightward to open and leftward to dose). When the rod is in the horizontal position, it lies flat in the bottom track of the sliding glass door, where it is below the top of the frame of the sliding panel, and thus will not obstruct the view through the panel at all. Because the rod is a single piece, it avoids any problem of dirt accumulating and fouling a complex folding mechanism. In the preferred embodiment of the invention, when the rod is horizontal, its end abuts the sliding panel, preventing it from being opened.

The rod is held in its vertical/inoperative position magnetically, a simpler and less visible approach than the bracket of Cohen and Evans. In the preferred embodiment, the rod is recessed into the door frame when in its vertical position, and in any case does not obstruct the view through the glass. The rod may have a rectangular cross-section, allowing it to blend in with the door frame. The rod is all but invisible if both it and the door frame are constructed of similar material, such as the same species of wood identically finished. The pivoting capability is provided by an unobtrusive butt hinge coupling the rod to the door frame, whose flanges can themselves be recessed into both members. Because of its simplicity and dosed construction, the butt hinge will not foul, only occasionally requiring lubrication.

The need for a second bracket as in Cohen to hold the free end of the horizontal rod is also eliminated because the rod lies in the sliding door track. However, to make the rod somewhat less likely to be dislodged from its horizontal position, the end of the rod in the preferred embodiment can be secured magnetically when horizontal.

In another embodiment of the invention, to provide ventilation, the rod is shorter by some distance D (typically several centimeters) than the full distance from its pivot point to the right frame of the dosed sliding panel, so that the sliding panel can open by a corresponding length D when the rod is horizontal. With this configuration, it is somewhat more likely that the operational locking rod 200 could get dislodged, so magnetic retention of the rod in its horizontal position becomes a more important consideration.

### BRIEF DESCRIPTION OF THE DRAWINGS

FIG. 1 is an isometric drawing showing the two panels of a sliding patio door system, and how the locking rod of the present invention changes position by rotating about its pivot axis.

FIG. 2 is a front view of the locking rod of the present invention held magnetically in its vertical/inoperative position by a vertical retainer.

FIG. 3 is an isometric drawing of the butt hinge about which the locking rod rotates, recessed into the rod and the door frame near the bottom of the outside edge of the fixed panel.

FIG. 4 is a top cross-sectional view showing the locking rod in its horizontal/operative position, abutting the sliding panel.

FIG. 5 is a top cross-sectional view showing an alternate embodiment of the invention having a shortened rod to allow the sliding door to open slightly to provide ventilation.

### DETAILED DESCRIPTION OF THE INVENTION

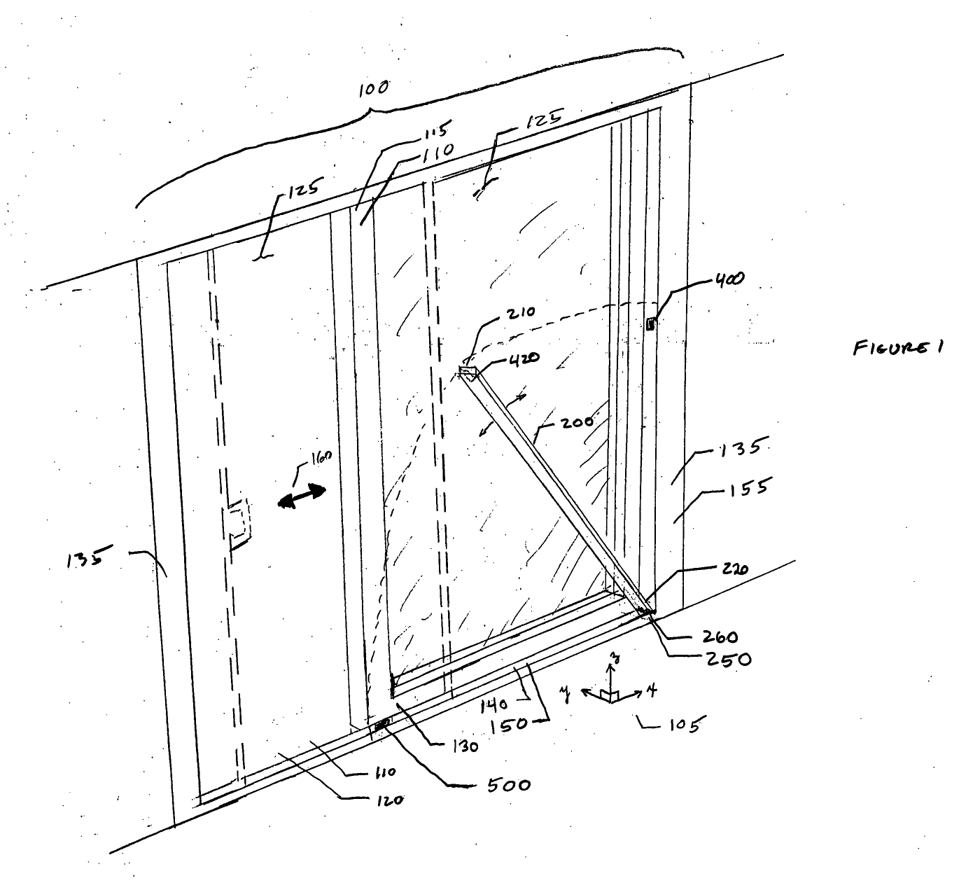

FIG. 1 shows the type of sliding door system 100 contemplated by the present invention. Coordinate directions 105 are provided in this and all other drawings to assist in providing orientation. The door system 100 consists of two panels 110, a fixed panel 115 and a sliding panel 120. The sliding panel 120 is moved horizontally within two tracks 140 attached to the door frame 135, a top track 145 (not shown) and a bottom track 150. In the figure, the sliding panel 120 is the left panel, and has a movement direction 160 rightward to open and leftward to dose. The reverse arrangement is also common. Typically, each panel 110 consists of a glass pane 125, within its own panel frame 130. The sliding panel 120 is the inner panel 110, and the fixed panel 115 is the outer panel 110. The locking rod 200 pivots about pivotally mounted at the right end of the bottom track 150, so that the rod 200 can be rotated counterclockwise to move from its vertical position 230 to its horizontal position 240. The rotation axis 260 is provided in the preferred embodiment by a butt hinge, attached to the locking rod 200 and to the right door frame member 155. The locking rod 200 is held magnetically in its vertical position by a vertical retainer 400. In the preferred embodiment, a locking rod magnet 420 in the locking rod 200 is attracted to a magnet or plate including some ferromagnetic material in the vertical retainer 400. According to the American Heritage Dictionary, “ferromagnetic” is defined as “[o]f or characteristic of substances such as iron, nickel, or cobalt and various alloys that exhibit extremely high magnetic permeability, a characteristic saturation point, and magnetic hysteresis.” Note that a ferromagnetic material is not necessarily a magnet, and need not contain iron.

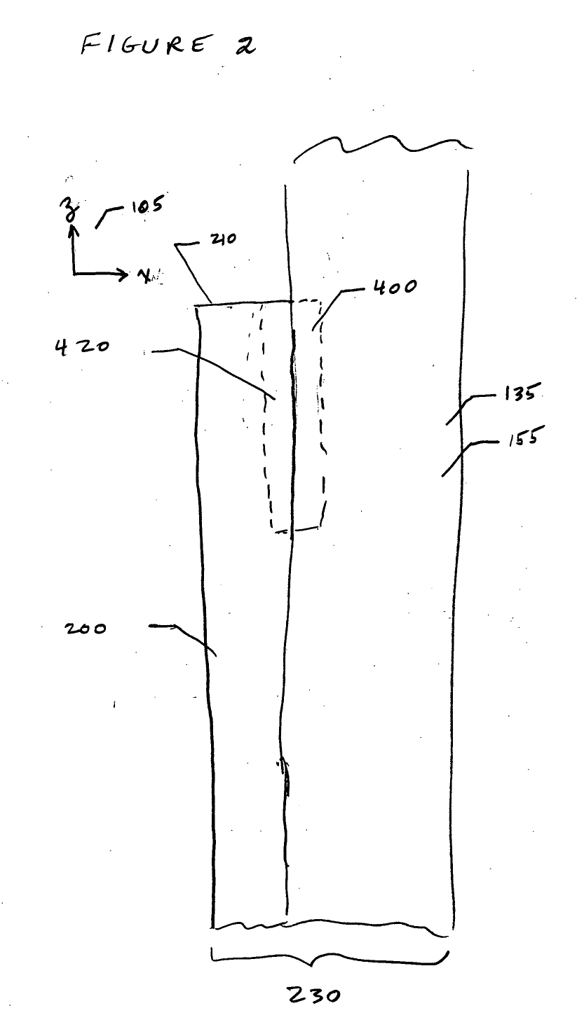

FIG. 2 shows details of the locking rod magnet 420 in contact with the ferromagnetic vertical retainer 400 within the right door frame member 155 when the locking rod 200 is in its vertical position 230. A variation of this where only one of the vertical retainer 400 and the adjacent part of locking rod 200 is a magnet, and the other contains ferromagnetic material (e.g., iron or steel), is well within the scope of the present invention.

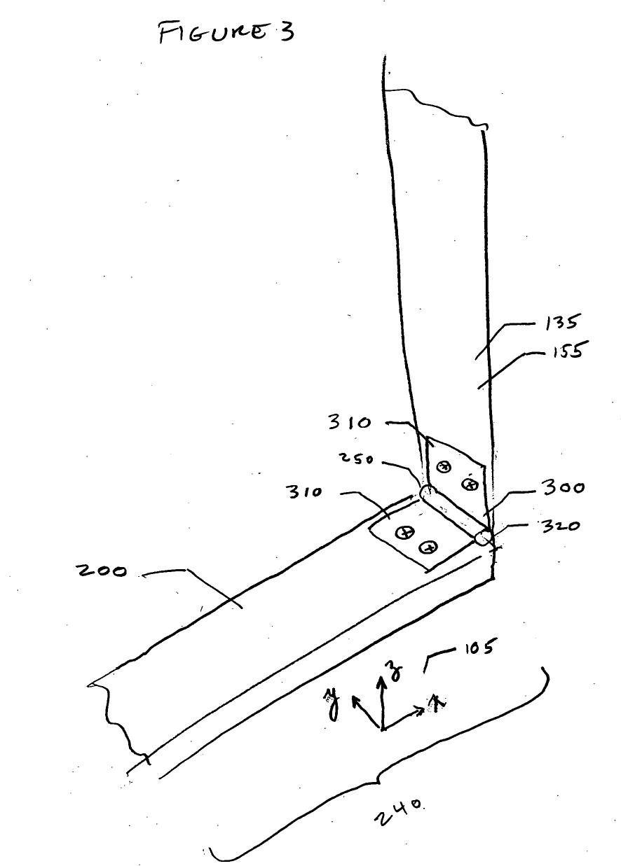

In the preferred embodiment shown in FIG. 3, one flange 310 of a butt hinge 300 is attached to the right door frame member 155, and the other flange 310, to the locking rod 200. The flanges 310 may be recessed into the right door frame member 155 and the locking rod 200, respectively, allowing the locking rod 200 to fold flat about the knuckle 320 of the butt hinge 300.

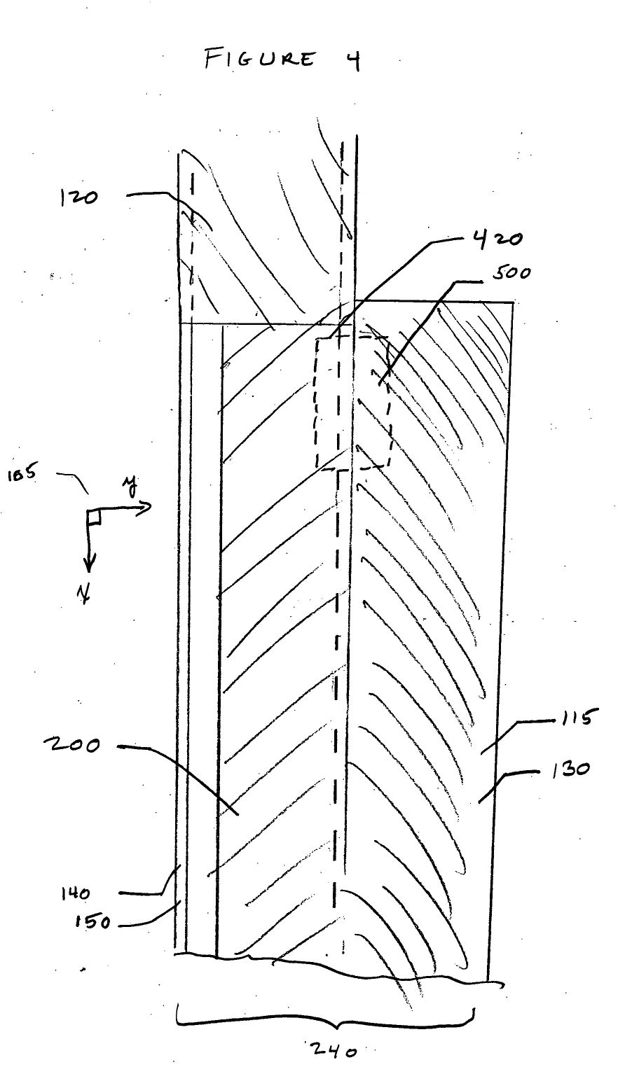

FIG. 4 shows the locking rod 200 in its horizontal position 240, in the bottom track 150 where it is engaged and abutting the sliding panel 120. In the preferred embodiment, a magnetic configuration, analogous to the one used to hold the locking rod 200 in its vertical position 230, is employed to hold the locking rod 200 more securely in its horizontal position 240. A horizontal retainer 500 containing ferromagnetic material is located either within the track or immediately adjacent to the track in the frame of the fixed panel 115. A matching area of ferromagnetic material is contained in the locking rod 200. In the preferred embodiment, the horizontal retainer 500 is a horizontal retainer plate 510, which is a plate magnet mounted on (or recessed into) the fixed panel frame. The same locking rod magnet 420 that couples the locking rod 200 to the vertical retainer plate 410 in the vertical position 230 also might also be used to couple it to the horizontal retainer plate 510 in the horizontal position 240; alternately, separate magnets can be used. In another alternate embodiment, no magnetic retention is used when the locking rod 200 is horizontal.

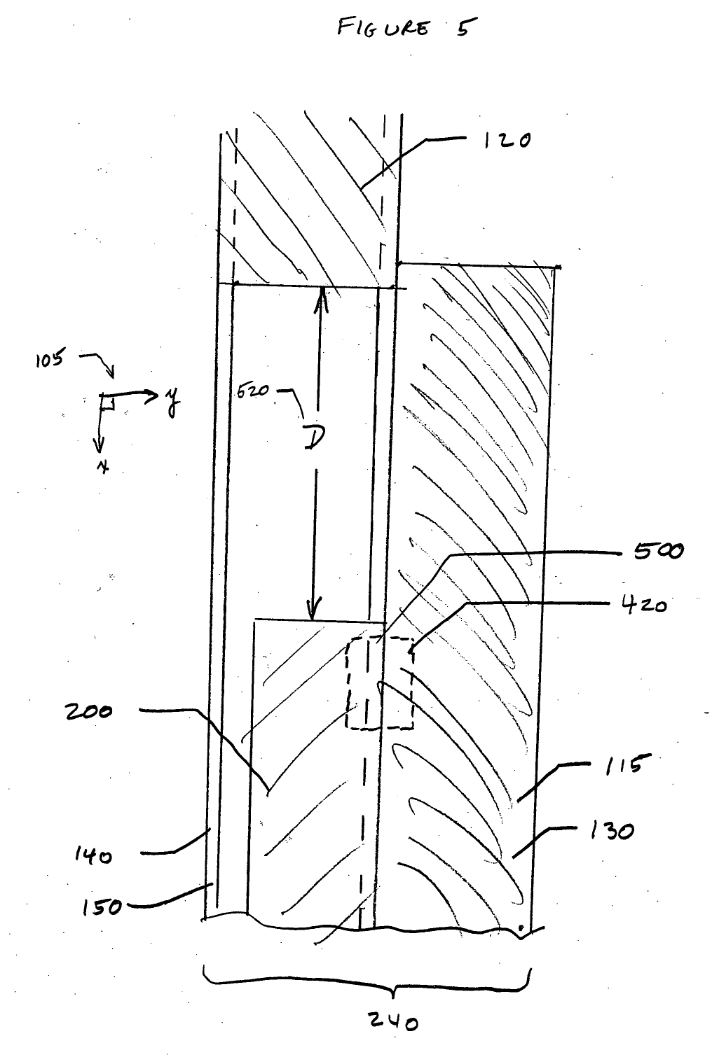

FIG. 5 shows a second alternate embodiment of the present invention, in which the locking rod 200 has been shortened by a distance D 520 (typically several centimeters but in all cases at least one centimeter) so that even when the locking rod 200 is in its operative horizontal position, the sliding door can be opened by the same amount D 520 to provide ventilation. Obviously, this approach relinquishes a certain amount of security in exchange for the fresh air. In this configuration, including the optional horizontal retainer 500 becomes more important because the locking rod 200 when horizontal can more easily become dislodged by the door, perhaps in combination with a foreign object in the bottom track 150, as the door is moved from its dosed to its partially open position.

The present invention is not to be limited to all of the above details, as modifications and variations may be made without departing from the intent or scope of the invention. For example, different types of magnets could be used in the vertical position 230. Consequently, the invention should not be limited by the specifics of the above description, but rather be limited only by the following claims and equivalent constructions.

What is claimed is:

1. A sliding door system with locking rod, comprising:
a) a sliding door system, including:
(i) a door frame including a frame top, a first door frame side, a second door frame side;
(ii) a track mounted on the floor, parallel to the plane of the door frame;
(iii) a fixed panel, comprising a rectangular fixed panel frame enclosing an essentially transparent pane, attached to the door frame abutting the first door frame side; and
(iv) a sliding panel, comprising a rectangular sliding panel frame enclosing an essentially transparent pane and adapted to horizontal motion along the track between a dosed position abutting the second door frame side and an open position;
b) a rod pivotally attached to the first door frame side along a rotation axis at the intersection of the track and the first door frame side, having a pivot end and a free end; and
c) a horizontal rod position, wherein the rod rests within the track.

2. The sliding door system with locking rod of claim 1, further comprising:
d) a vertical retainer attached to the first door frame; and
e) a vertical rod position wherein the rod is magnetically held vertical by contact with the vertical retainer.

3. The sliding door system with locking rod of claim 2, wherein when the rod in its vertical position it is recessed into the first side of the door frame.

4. The sliding door system with locking rod of claim 2, wherein the vertical retainer includes ferromagnetic material and the rod contains a first magnet that is in contact with the ferromagnetic material of the vertical retainer when the rod is in its vertical position.

5. The sliding door system with locking rod of claim 3, wherein the ferromagnetic material of the vertical retainer comprises a plate that is recessed into the first side of the door frame.

6. The sliding door system with locking rod of claim 1, wherein, when the rod is in its horizontal position, the free end of the rod is in contact with the sliding panel frame when the sliding panel is in its dosed position.

7. The sliding door system with locking rod of claim 1, wherein the length of the rod is shorter than the distance from its rotation axis to the sliding panel when the sliding panel is in its dosed position.

8. The sliding door system with locking rod of claim 1, wherein the rod is pivotally mounted to the first door frame side by a hinge.

9. The sliding door system with locking rod of claim 8, wherein the hinge is a butt hinge.

10. The sliding door system with locking rod of claim 8, wherein the hinge is recessed into the rod and the door frame.

11. The sliding door system with locking rod of claim 1, further comprising:
d) a horizontal retainer, attached to the track or to the rectangular frame of the fixed panel, such that the rod is held in its horizontal position by the horizontal retainer.

12. The sliding door system with locking rod of claim 11, wherein, when the rod is in its horizontal position, it is held magnetically to the horizontal retainer.

13. The sliding door system with locking rod of claim 12, wherein the horizontal retainer includes ferromagnetic material and the rod contains a magnet that is in contact with the ferromagnetic material of the horizontal retainer when the rod is in its horizontal position.

14. The sliding door system with locking rod of claim 12, wherein when the rod is in its vertical position, it is held magnetically to the vertical retainer.

15. The sliding door system with locking rod of claim 13, wherein the vertical retainer includes ferromagnetic material and when the rod is in its vertical position, the magnet is in contact with the ferromagnetic material of the vertical retainer.

16. A sliding door apparatus, comprising:
a) a rectangular door frame, having a top member, a first side member, and a second side member;
b) a fixed panel, between the top member of the door frame, the first side member of the door frame, and the floor;
c) a door bottom track extending from the first side member of the door frame to the second side member of the door frame along the floor;
d) a single-piece locking rod, having an essentially rectangular cross-section, a free end, and a pivot end;
e) a hinge, pivotally connecting the rod to the first side member of the door frame;
f) a horizontal rod retainer which holds the rod in a horizontal rod position, wherein the rod rests within the bottom door track and is magnetically secured to the horizontal rod retainer;
g) a vertical rod retainer attached to the first side member of the door frame, wherein the vertical rod retainer holds the rod in a vertical rod position with the rod recessed into the first side member of the door frame and magnetically secured by the vertical rod retainer; and
h) a sliding panel extending from the door frame top member to the bottom track, capable when the rod is in its vertical position of moving horizontally from a closed position abutting the second side member of the door frame to a continuity of open positions, guided by the bottom door track;
and wherein when the rod is in its horizontal position and the sliding panel is in its dosed position, there is a separation between the free end of the rod and the sliding panel of at least one centimeter.

17. A method for operating a sliding door with a single-piece locking bar, comprising:
a) securing the locking bar in a vertical position magnetically by contact with a vertical retainer such that the locking bar is recessed into a first door frame side member;
b) sliding a sliding panel horizontally along a bottom track from a dosed position abutting a second door frame side member to an open position;
c) sliding the sliding panel horizontally from the open position to the closed position; and
d) rotating the locking bar around a rotation axis provided by a hinge from the vertical position to a horizontal position, wherein the locking bar lies within the bottom track and is secured magnetically by contact with a horizontal retainer.

18. The method of claim 17, wherein the length of the locking bar is less than the distance between the rotation axis and the sliding panel, when the sliding panel is in its dosed position, by at least one centimeter:
